(19) United States
(12) Patent Application Publication
(10) Pub. No.: US 2006/0172207 A1
(43) Pub. Date: Aug. 3, 2006

(54) Exposure analyzing system, method for analyzing exposure condition, and method for manufacturing semiconductor device

(76) Inventors: Megumi Asaba, Chigasaki-shi (JP); Kenji Yoshida, Oita-shi (JP); Masatoshi Ueda, Oita-shi (JP); Shoji Mimotogi, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/044,266

(22) Filed: Jan. 28, 2005

(51) Int. Cl. G03C 5/00

(52) U.S. Cl. 430/30

(57) ABSTRACT

An exposure analyzing system includes a microscope measuring CDs in resist patterns, each of the resist patterns being formed by specific defocus and dose conditions, an exposure condition calculator calculating functions of the specific defocus and dose conditions, each of the functions giving one of the CDs, an image arranger arranging images of the resist patterns in a matrix having a first coordinate axis arranging the defocus conditions and a second coordinate axis arranging the dose conditions, and a graphic controller displaying the images and the functions in a coordinate plane implemented by the first and second coordinate axes.

### INCORPORATION BY REFERENCE

The entire contents of which are incorporated by reference herein.

### BACKGROUND OF THE INVENTION

1. Field of the Invention

The present invention relates to photolithography techniques and in particular to an exposure analyzing system, a method for analyzing an exposure condition, and a method for manufacturing a semiconductor device.

2. Description of the Related Art

In a semiconductor device manufacturing process, accuracy of a lithography process is a crucial factor for reducing a size of the semiconductor device. In a case where a mask pattern is projected onto a resist, optimizing focus offset and dose conditions is necessary to improve a reliability of the semiconductor device. In earlier methods for optimizing the focus offset and the dose conditions, the mask pattern is projected onto the resist by using a plurality of defocus and dose conditions to form a plurality of resist patterns. Then, an operator observes the resist patterns with a microscope one by one to determine the focus offset and the dose conditions for manufacturing the semiconductor device. In this case, a vast number of defocus and dose conditions are employed to form the resist patterns. Therefore, relating the resist patterns with the defocus and dose conditions one by one takes a long time. In Japanese Patent Laid-Open Publication No. Hei11-288879, a method for collecting microscope images of resist patterns by a computer and displaying the images, critical dimensions in the resist patterns, and the defocus and dose conditions used to form the resist patterns is proposed. However, the microscope images, the critical dimensions, and the defocus and dose conditions are displayed separately. Therefore, the operator still needs to relate the resist patterns with the defocus and dose conditions to determine the focus offset and the dose conditions for manufacturing the semiconductor device. Such work still takes a long time.

### SUMMARY OF THE INVENTION

An aspect of present invention inheres in an exposure analyzing system according to an embodiment of the present invention. The exposure analyzing system includes a microscope configured to measure a plurality of critical dimensions in resist patterns, each of the resist patterns being formed by specific defocus and dose conditions, an exposure condition calculator configured to calculate functions of the specific defocus and dose conditions, each of the functions giving one of the critical dimensions, an image arranger configured to arrange images of the resist patterns in a matrix having a first coordinate axis arranging the plurality of defocus conditions and a second coordinate axis arranging the plurality of dose conditions, and a graphic controller configured to control a displaying the arranged images and the functions in a coordinate plane implemented by the first and second coordinate axes.

Another aspect of present invention inheres in a method for analyzing exposure condition according to an embodiment of the present invention. The method for analyzing exposure condition includes measuring a plurality of critical dimensions in resist patterns, each of the resist patterns being formed by specific defocus and dose conditions, calculating functions of the specific defocus and dose conditions, each of the functions giving one of the critical dimensions, arranging images of the resist patterns in a matrix having a first coordinate axis arranging the plurality of defocus conditions and a second coordinate axis arranging the plurality of dose conditions, and displaying the arranged images and the functions in a coordinate plane implemented by the first and second coordinate axes.

Yet another aspect of the present invention inheres in a method for manufacturing a semiconductor device according to an embodiment of the present invention. The method for manufacturing the semiconductor device includes projecting a mask pattern onto a first resist by using each of a plurality of specific defocus and dose conditions, forming a plurality of resist patterns corresponding to the specific defocus and dose conditions, respectively, by developing the first resist, obtaining a plurality of images of the resist patterns, measuring a plurality of critical dimensions in the resist patterns, respectively, calculating functions of the specific defocus and dose conditions, each of the functions giving one of the critical dimensions, arranging the images in a matrix having a first coordinate axis arranging the plurality of defocus conditions and a second coordinate axis arranging the plurality of dose conditions, displaying the arranged images and the functions in a coordinate plane implemented by the first and second coordinate axes, requesting an input of a focus offset and dose condition for manufacturing the semiconductor device, projecting the mask pattern onto a second resist by using the focus offset and dose condition for manufacturing the semiconductor device, and developing the second resist.

### BRIEF DESCRIPTION OF DRAWINGS

FIG. 1 is a diagram of an exposure analyzing system in accordance with an embodiment of the present invention;

FIG. 2 illustrates an exposure tool in accordance with the embodiment of the present invention;

FIG. 3 is an exampled focus exposure matrix for the exposure tool in accordance with the embodiment of the present invention;

FIG. 4 is an exampled information table for a microscope in accordance with the embodiment of the present invention;

FIG. 5 is an exampled text based file converted from the information table in accordance with the embodiment of the present invention;

FIG. 6 is a sample graph of defocus versus dose in accordance with the embodiment of the present invention;

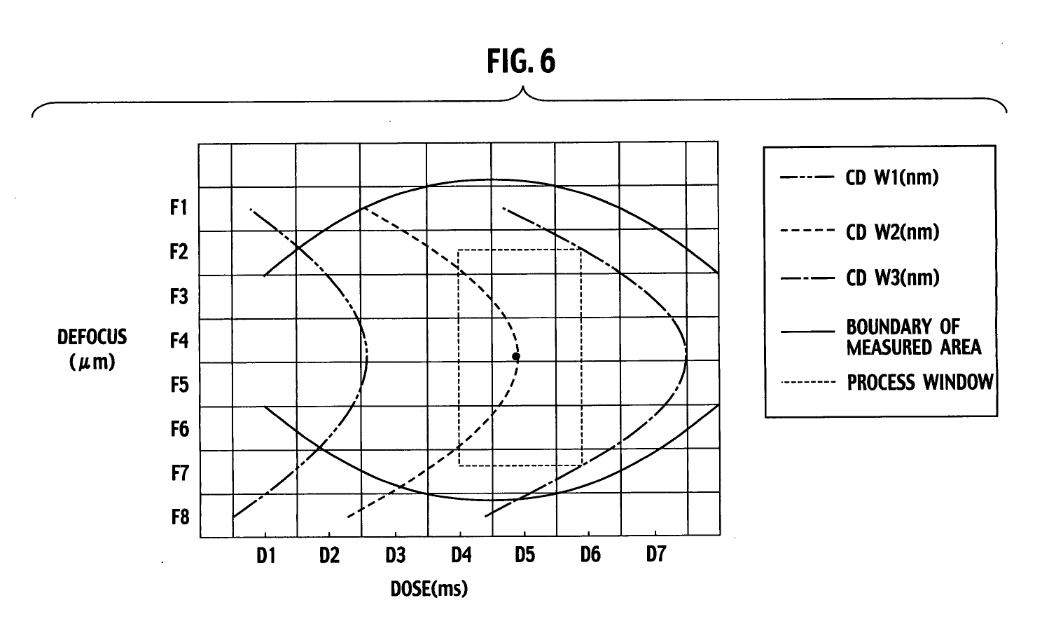

FIG. 7 is an example of an illustration of a computer display showing analysis results in accordance with the embodiment of the present invention; and

FIG. 8 is a flowchart depicting a method for manufacturing a semiconductor device in accordance with the embodiment of the present invention.

### DETAILED DESCRIPTION OF THE INVENTION

An embodiment of the present invention will be described with reference to the accompanying drawings. It is to be noted that the same or similar reference numerals are applied to the same or similar parts and elements throughout the drawings, and the description of the same or similar parts and elements will be omitted or simplified.

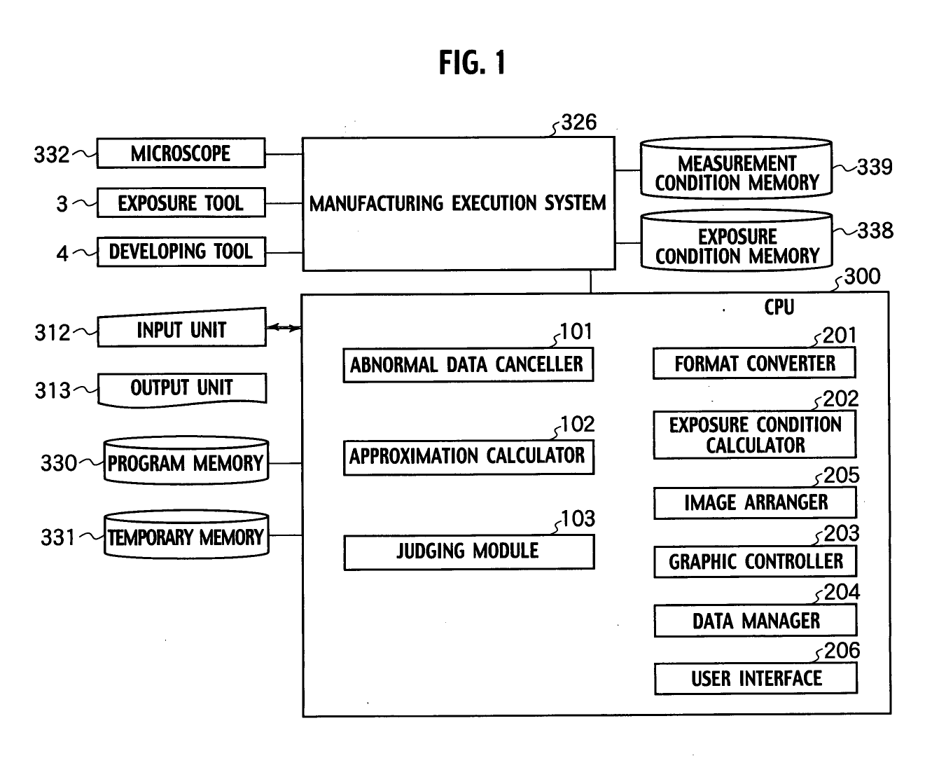

With reference to FIG. 1, an exposure analyzing system, in accordance with an embodiment of the present invention, includes a microscope 332 and a central processing unit (CPU) 300. The microscope 332 is configured to measure a plurality of actual critical dimensions (CDs) in resist patterns, each of the resist patterns being formed by using specific defocus and dose conditions. The CPU 300 includes an exposure condition calculator 202 configured to calculate functions of the defocus and dose conditions (ED functions) each of the ED functions giving one of the actual CDs, an image arranger 205 configured to arrange images of the resist patterns in a matrix having a first coordinate axis arranging the plurality of defocus conditions and a second coordinate axis arranging the plurality of dose conditions, and a graphic controller 203 configured to control a displaying the arranged images and the function in a coordinate plane implemented by the first and second coordinate axes. Here, the “CD” is the distance between line-space boundaries at a given cross section of a feature such as a line width.

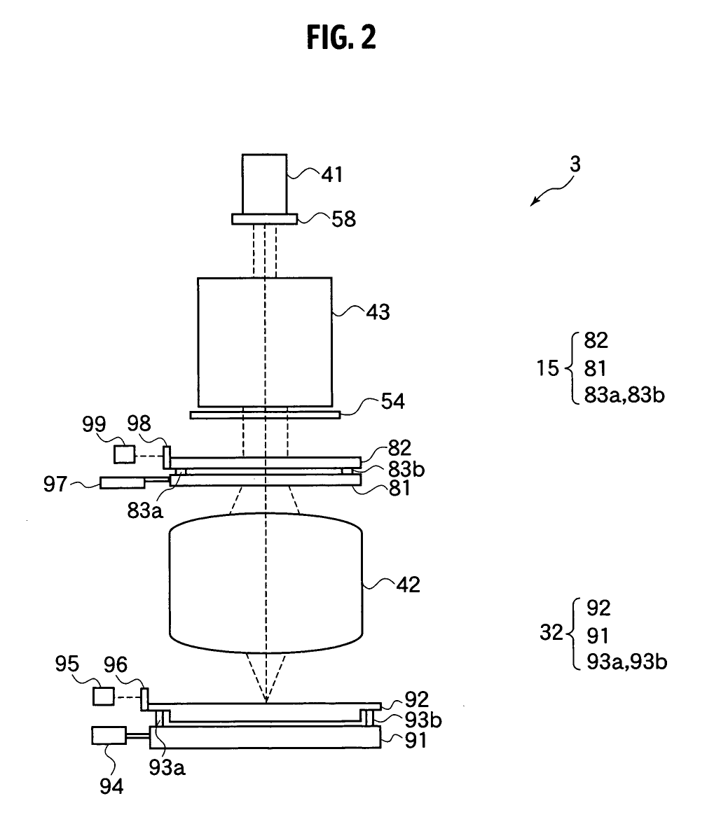

The exposure analyzing system further includes an exposure tool 3, a developing tool 4, and a manufacturing execution system 326. With reference to FIG. 2, the exposure tool 3 includes a light source 41 emitting a light, an aperture diaphragm holder 58 disposed under the light source 41, an illuminator 43 condensing the light emitted from the light source 41, a slit holder 54 disposed under the illuminator 43, a reticle stage 15 disposed beneath the slit holder 54, a projection optical system 42 disposed beneath the reticle stage 15, and a wafer stage 32 disposed beneath the projection optical system 42.

The reticle stage 15 includes a reticle XY stage 81, shafts 83a, 83b provided on the reticle XY stage 81, and a reticle tilting stage 82 attached to the reticle XY stage 81 through the shafts 83a, 83b. The reticle stage 15 is attached to a reticle stage aligner 97. The reticle stage aligner 97 aligns the position of the reticle XY stage 81. Each of the shafts 83a, 83b extends from the reticle XY stage 81. Therefore, the position of the reticle tilting stage 82 is determined by the reticle XY stage 81. The tilt angle of the reticle tilting stage 82 is determined by the shafts 83a, 83b. Further, a reticle stage mirror 98 is attached to the edge of the reticle tilting stage 82. The position of the reticle tilting stage 82 is monitored by an interferometer 99 disposed opposite the reticle stage mirror 98.

The wafer stage 32 includes a wafer XY stage 91, shafts 93a, 93b provided on the wafer XY stage 91, and a wafer tilting stage 92 attached to the wafer XY stage 91 through the shafts 93a, 93b. The wafer stage 32 is attached to a wafer stage aligner 94. The wafer stage aligner 94 aligns the position of the wafer XY stage 91. Each of the shafts 93a, 93b extends from the wafer XY stage 91. Therefore, the position of the wafer tilting stage 92 is determined by the wafer XY stage 91. The tilt angle of the wafer tilting stage 92 is determined by the shafts 93a, 93b. Further, a wafer stage mirror 96 is attached to the edge of the wafer tilting stage 92. The position of the wafer tilting stage 92 is monitored by an interferometer 95 disposed opposite the wafer stage mirror 96.

With reference again to FIG. 1, the developing tool 4 is configured to develop a resist exposed to the light. Developing conditions of the developing tool 4 are controllable. The developing conditions include concentration of a developer solution, the solution temperature, and the developing time. An atomic force microscope (AFM) and a scanning electron microscope (SEM) can be used for the microscope 332. The microscope 332 is configured to observe a surface of the resist exposed to the light and developed with the developing tool 4. By observing, the microscope 332 obtains images of the resist patterns formed in the resist and measures the actual CDs in the resist patterns.

The manufacturing execution system 326 controls the exposure conditions of the exposure tool 3. For example, the manufacturing execution system 326 instructs the reticle stage aligner 97 shown in FIG. 2 and the wafer stage aligner 94 to shift and tilt the reticle stage 15 and the wafer stage 32. The manufacturing execution system 326 also monitors the orientation, the shift direction, and the shift speed of the reticle stage 15 and the wafer stage 32 by using the interferometer 99 and the interferometer 95. Also, the manufacturing execution system 326 shown in FIG. 1 adjusts the developing conditions of the developing tool 4. Further, the manufacturing execution system 326 adjusts the measurement conditions of the microscope 332, such as the scan size, the scan rate, and the resolution. The manufacturing execution system 326 transfers images obtained by the microscope 332 to the CPU 300.

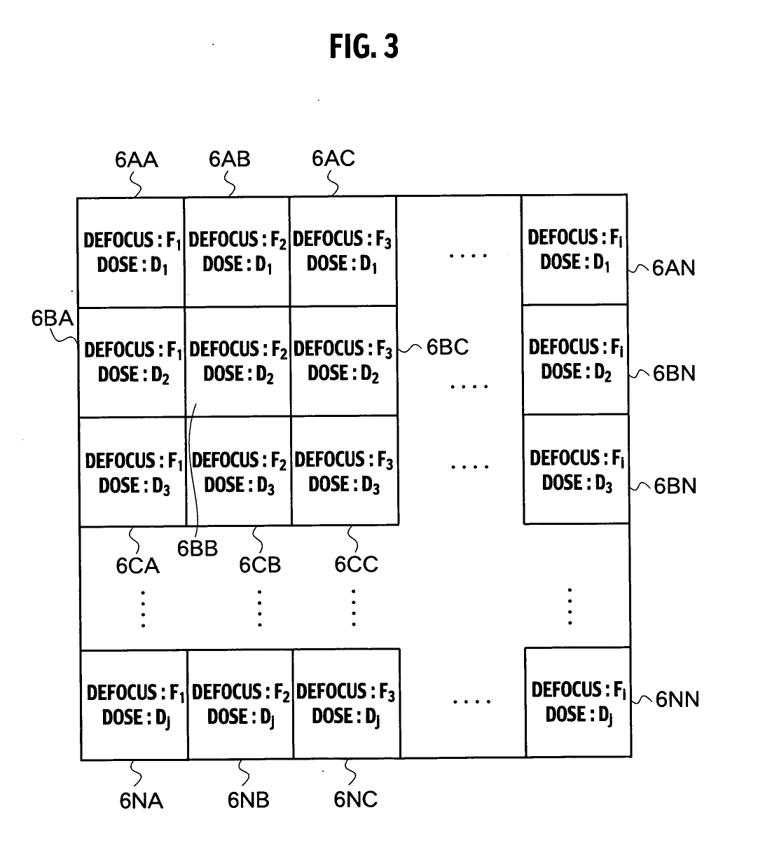

An exposure condition memory 338 and a measurement condition memory 339 are also connected to the manufacturing execution system 326. The exposure conditions for the exposure tool 3 are stored in the exposure condition memory 338. With reference to FIG. 3, the exposure condition memory 338 shown in FIG. 1 stores exposure conditions 6AA, 6AB, 6AC, -, 6AN, 6BA, 6BB, 6BC, -, 6BN, 6CA, 6CB, 6CC, -, 6CN, 6NA, 6NB, 6NC, -, 6NN for step and scan processes by the exposure tool 3. In each of the exposure conditions 6AA-6NN, a defocus “Fᵢ” (i=1, 2, 3, -) and a dose “Dⱼ” (J=1, 2, 3, -) for projecting a mask pattern on to the resist are defined. Thus, the exposure conditions 6AA-6NN form a focus exposure matrix (FEM). Here, the “defocus” means a perpendicular distance between a focal point of the projection optical system 42 shown in FIG. 2 and the top of the resist coated on a substrate mounted on the wafer stage 32 of the exposure tool 3.

The exposure condition memory 338 shown in FIG. 1 also stores the numerical aperture (NA) of the projection optical system 42 shown in FIG. 2, a coherence factor “σ”, an aperture type for annular or quadrupolar illumination, and the developing condition for the developing tool 4 shown in FIG. 1. Further, the exposure condition memory 338 stores information on the product name of a semiconductor device manufactured by using the mask pattern, the lot number, and machine type on the exposure tool 3. The measurement condition memory 339 stores the measurement conditions for the microscope 332.

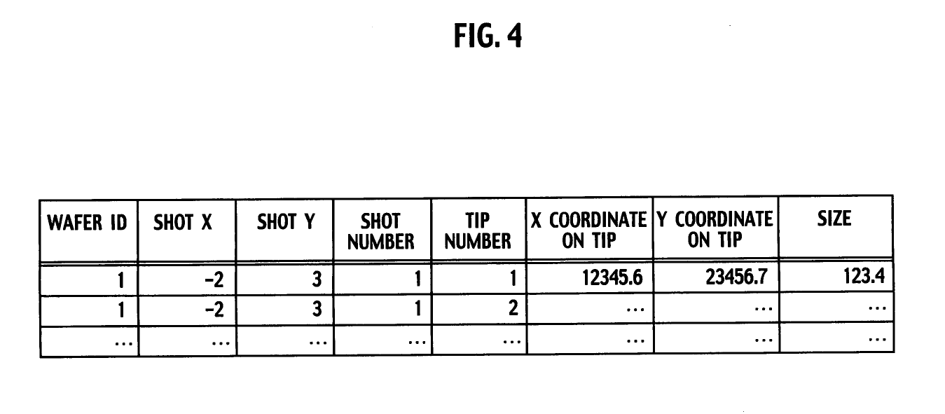

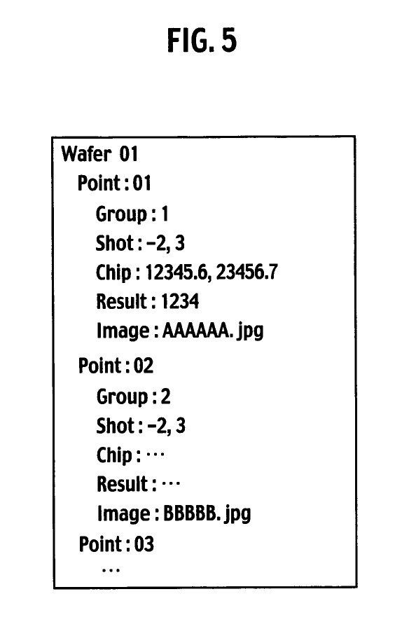

The CPU 300 further includes a format converter 201, an abnormal data canceller 101, an approximation calculator 102, a judging module 103, a user interface 206, and a data manager 204. The format converter 201 obtains the images containing information of the actual CDs, the product name, the lot number, and the machine type information on the exposure tool 3. Further, the format converter 201 converts the file type of the image that contains information such as a unit of a measured value, a shot coordinate, and a tip coordinate, into a standard format independent of the type of machine of the microscope 332. For example, as shown in FIG. 4, in a case where the file type contains a table structure specific to the type of machine of the microscope 332, the format converter 201 converts the file type to a text based file format independent of the type of machine of the microscope 332 as shown in FIG. 5. Thus, the text based file format such as the HTML format and the XML format can be used for the standard format.

The abnormal data canceller 101 compares each of the actual CDs with an allowable upper limit of the CD and an allowable lower limit of the CD. In a case where the actual CD is beyond the limits of the allowable range, the abnormal data canceller 101 defines such actual CD as abnormal data and excludes the abnormal data from data proces sing in the CPU 300. The approximation calculator 102 calculates an approximate function expressing a relation between the defocus and the CD based on the actual CDs and the exposure conditions 6AA-6NN. The judging module 103 calculates a residual sum of squares of each of the actual CDs and an approximated CD calculated by the approximate function. In a case where an actual CD giving the residual sum of squares that is above a threshold exists, the judging module 103 instructs the abnormal data canceller 101 to reduce the allowable range to strictly exclude the abnormal data.

The exposure condition calculator 202 calculates the ED function of the specific defocus and dose condition giving a constant value of the CD based on the actual CD values filtered by the abnormal data canceller 101. The ED function is given by equation (1).
C_{CD}=f (Defocus, Exposure) (1)

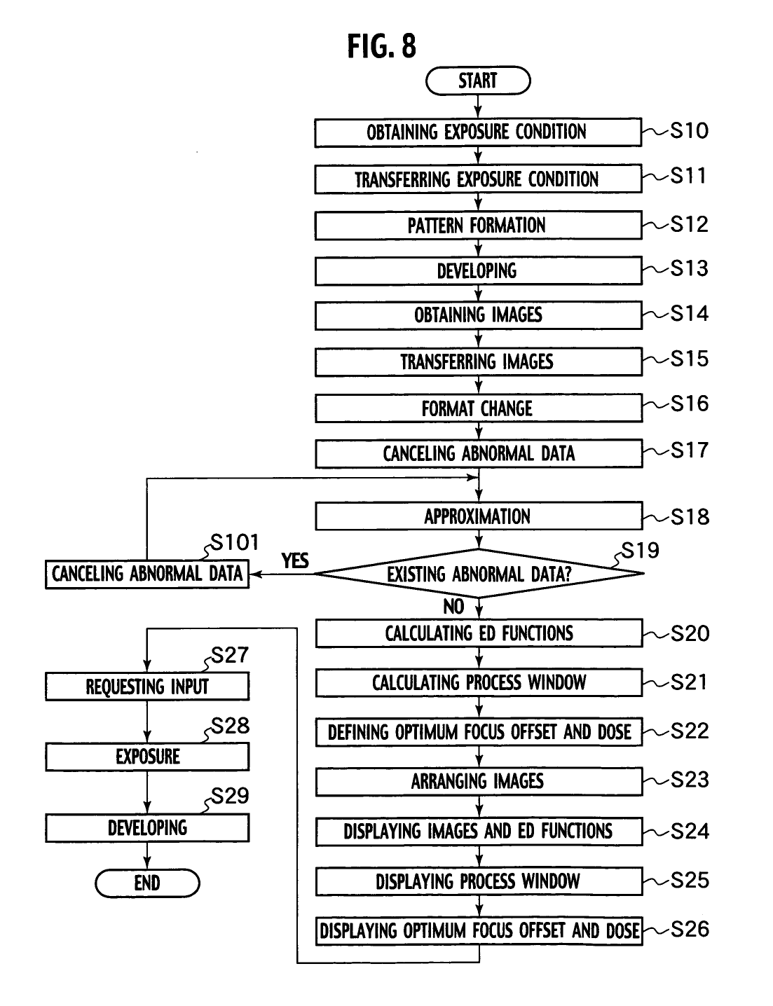

Here, C_{CD} is the constant value of the CD. In FIG. 8, the ED functions giving W1 nm of the CD, W2 nm of the CD, and W3 nm of the CD respectively are plotted. Here, W1 nm is an allowable minimum CD, W2 nm is a target CD, and W3 nm is an allowable maximum CD. Further, the exposure condition calculator 202 calculates a process window tangent to an ED function giving a predetermined narrow CD and an ED function giving a predetermined wide CD for manufacturing the semiconductor device. The exposure condition calculator 202 defines the defocus and dose conditions at the center of the process window as an optimum focus offset and an optimum dose.

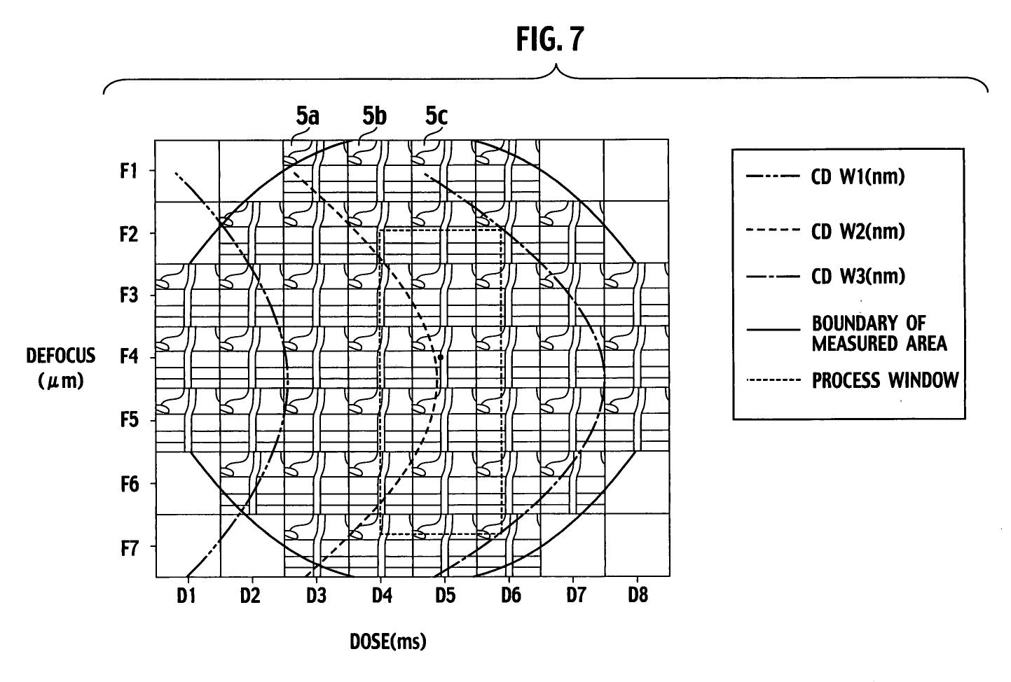

The graphic controller 203 instructs an output unit 313 connected to the CPU 300 to display the arranged images and the ED functions in the coordinate plane implemented by the first and second coordinate axes. An LCD or an LED may be used for the output unit 313. A display example on the output unit 313 is shown in FIG. 7. In the coordinate plane, the abscissa shows the dose condition and the ordinate shows the defocus condition. The images 5a, 5b, 5c are arranged in the FEM having the first coordinate axis arranging the plurality of defocus conditions and the second coordinate axis arranging the plurality of dose conditions. Also, the ED functions, the process window, the optimum focus offset, and the optimum dose are drawn on the images 5a-5c. The user interface 206 shown in FIG. 1 instructs the output unit 313 to display a message to request an input of a focus offset and dose condition for manufacturing the semiconductor device. The data manager 204 manages data transfer within the CPU 300 or with apparatuses connected to the CPU 300. The data manager 204 stores the focus offset and dose condition for manufacturing the semiconductor device in the exposure condition memory 338.

An input unit 312, a program memory 330, and a temporary memory 331 are also connected to the CPU 300. A keyboard and a mouse may be used for the input unit 312. The program memory 330 stores a program instructing the CPU 300 to transfer data with apparatuses connected to the CPU 300. The temporary memory 331 stores temporary data calculated during operation by the CPU 300.

With reference next to FIG. 8, a method for manufacturing the semiconductor device according to the embodiment of the present invention is described.

In step S10, the manufacturing execution system 326 reads the exposure conditions 6AA-6NN that is shown in FIG. 3 and is stored in the exposure condition memory 338. In step S11, the manufacturing execution system 326 transfers the exposure conditions 6AA-6NN to the exposure tool 3. In step S12, the exposure tool 3 projects the mask pattern onto a first resist under each of the exposure conditions 6AA-6NN with the step and scan process.

In step S13, a post exposure bake (PEB) and the developing is performed for the first resist. In step S14, the microscope 332 observes the resist patterns formed in the first resist under the exposure conditions 6AA-6NN. Thereafter, the microscope 332 obtains the images of the resist patterns. Subsequently, the microscope 332 measures the actual CDs in the resist patterns from the images. In step S15, the manufacturing execution system 326 transfers the images containing the information of the actual CDs obtained by the microscope 332 and the exposure conditions 6AA-6NN to the format converter 201 in the CPU 300.

In step S16, the format converter 201 converts the file type of the image specific to the machine type of the microscope 332 into the standard format. The converted files are transferred to the abnormal data canceller 101. In step S17, the abnormal data canceller 101 determines whether each of the CDs is within the allowable range or not. Thereafter, the abnormal data canceller 101 excludes the abnormal data from data processing in the CPU 300.

In step S18, the approximation calculator 102 calculates the approximate function expressing the relation between the defocus and the CD based on the filtered actual CDs. In step S19, the judging module 103 calculates the residual sum of squares of each of the actual CDs and approximated CD calculated by the approximate function. In the case where the actual CD giving the residual sum of squares that is above the threshold exists, step S101 is next procedure. In the case where the actual CD giving the residual sum of squares that is above the threshold does not exist, step S20 is next procedure. In step S101, the abnormal data canceller 101 excludes the actual CD giving the residual sum of squares that is above the threshold from the processing.

In step S20, the exposure condition calculator 202 calculates the ED function given by the equation (1) based on the filtered actual CD. In step S21, the exposure condition calculator 202 calculates the process window tangent to the ED function giving the predetermined narrow CD and the ED function giving the predetermined wide CD for manufacturing the semiconductor device. The predetermined narrow and wide CDs are stored in the exposure condition memory 338.

In step S22, the exposure condition calculator 202 defines the defocus and dose conditions at the center of the process window as the optimum focus offset and the optimum dose. In step S23, the image arranger 205 arranges the images in the FEM by referring information on the exposure conditions 6AA-6NN shown in FIG. 3. If necessary, the image arranger 205 sets new sizes of the images based on a resolution of the output unit 313 shown in FIG. 1.

In step S24, the graphic controller 203 instructs the output unit 313 to display the images 5a-5c and the ED functions in the coordinate plane as shown in FIG. 7. In step S25, the graphic controller 203 instructs the output unit 313 to display the process window in the coordinate plane. In step S26, the graphic controller 203 instructs the output unit 313 to display the optimum focus offset and the optimum dose in the coordinate plane.

In step S27, the user interface 206 instructs the output unit 313 to display the message to request the input of the focus offset and dose condition for manufacturing the semiconductor device. In a case where the focus offset and dose condition for manufacturing the semiconductor device are entered from the input unit 312 by an operator, the data manager 204 transfers the focus offset and dose condition for manufacturing the semiconductor device to the manufacturing execution system 326 and stores the focus offset and dose condition for manufacturing the semiconductor device in the exposure condition memory 338.

In step S28, the manufacturing execution system 326 adjusts the exposure condition in the exposure tool 3. Subsequently, the exposure tool 3 projects the mask pattern onto a second resist under the focus offset and dose condition for manufacturing the semiconductor device. In step S29, the second resist is developed by using the developing tool 4 to form the resist pattern. Thereafter, the insulating film formation and the circuit layer formation are repeated until the manufacturing of the semiconductor device is completed.

In earlier methods, numerical data such as the ED functions and the images displayed separately on a display device. Therefore, the operator is required to find a relation between each of the numerical data and each of the images of the resist patterns formed under a plurality of exposure conditions. However, the exposure analyzing system shown in FIG. 1 according to the embodiment of the present invention displays the ED functions, the process window, the optimum focus offset and dose, and the images 5a-5c in the identical coordinate plane as shown in FIG. 7. Therefore, it is possible for the operator to confirm not only the numerical data such as the CD but also the shapes of the resist patterns at the same time to determine the focus offset and dose condition for manufacturing the semiconductor device. Consequently, a time consumed in finding the relation between each of the numerical data and each of the images by the operator may be eliminated. Since the operator can verify the shapes of the resist patterns in addition to the numerical data such as the CD at the same time, it is possible for the operator to determine whether an optical proximity correction (OPC) is required or not. Further, since it is possible to feed back the selected focus offset and dose condition for manufacturing the semiconductor device to a semiconductor manufacturing process instantly, total manufacturing time for the semiconductor device is reduced.

### Other Embodiments

Although the invention has been described above by reference to the embodiment of the present invention, the present invention is not limited to the embodiment described above. Modifications and variations of the embodiment described above will occur to those skilled in the art, in the light of the above teachings. For example, there is no need to dispose the manufacturing execution system 326 shown in FIG. 1 and the CPU 300 in a same place. Disposing the manufacturing execution system 326 and the CPU 300 in different places respectively and connecting the manufacturing execution system 326 and the CPU 300 via a computer network is also available. Also, an order of carrying out the step S20 to step S23 shown in FIG. 8 is changeable. Similarly, instead of carrying out step S25 and then step S26, step S26 may be carried out before o step S25. As described above, the present invention includes many variations of embodiments. Therefore, the scope of the invention is defined with reference to the following claims.

What is claimed is:

1. An exposure analyzing system comprising:
a microscope configured to measure a plurality of critical dimensions in resist patterns, each of the resist patterns being formed by specific defocus and dose conditions;
an exposure condition calculator configured to calculate functions of the specific defocus and dose conditions, each of the functions giving one of the critical dimensions;
an image arranger configured to arrange images of the resist patterns in a matrix having a first coordinate axis arranging the plurality of defocus conditions and a second coordinate axis arranging the plurality of dose conditions; and
a graphic controller configured to control a displaying the arranged images and the functions in a coordinate plane implemented by the first and second coordinate axes.

2. The system of claim 1, wherein the exposure condition calculator calculates a process window based on the functions.

3. The system of claim 2, wherein the graphic controller controls a displaying the process window in the coordinate plane.

4. The system of claim 2, wherein the exposure condition calculator defines the defocus and dose conditions at a center of the process window as an optimum focus offset and an optimum dose.

5. The system of claim 4, wherein the graphic controller controls a displaying the optimum focus offset and the optimum dose in the coordinate plane.

6. The system of claim 1, wherein the microscope is a scanning electron microscope.

7. The system of claim 1, further comprising a user interface configured to request an input of a focus offset and dose condition for manufacturing a semiconductor device.

8. The system of claim 7, further comprising an exposure tool configured to project a mask pattern onto a resist by using the focus offset and dose condition for manufacturing the semiconductor device.

9. A method for analyzing exposure condition comprising:
measuring a plurality of critical dimensions in resist patterns, each of the resist patterns being formed by specific defocus and dose conditions;
calculating functions of the specific defocus and dose conditions, each of the functions giving one of the critical dimensions;
arranging images of the resist patterns in a matrix having a first coordinate axis arranging the plurality of defocus conditions and a second coordinate axis arranging the plurality of dose conditions; and
displaying the arranged images and the functions in a coordinate plane implemented by the first and second coordinate axes.

10. The method of claim 9, further comprising calculating a process window based on the functions.

11. The method of claim 10, further comprising displaying the process window in the coordinate plane.

12. The method of claim 10, further comprising defining the defocus and dose conditions at a center of the process window as an optimum focus offset and an optimum dose.

13. The method of claim 12, further comprising displaying the optimum focus offset and the optimum dose in the coordinate plane.

14. A method for manufacturing a semiconductor device comprising:
projecting a mask pattern onto a first resist by using each of a plurality of specific defocus and dose conditions;
forming a plurality of resist patterns corresponding to the specific defocus and dose conditions, respectively, by developing the first resist;
obtaining a plurality of images of the resist patterns;
measuring a plurality of critical dimensions in the resist patterns, respectively;
calculating functions of the specific defocus and dose conditions, each of the functions giving one of the critical dimensions;
arranging the images in a matrix having a first coordinate axis arranging the plurality of defocus conditions and a second coordinate axis arranging the plurality of dose conditions;
displaying the arranged images and the functions in a coordinate plane implemented by the first and second coordinate axes;
requesting an input of a focus offset and dose condition for manufacturing the semiconductor device;
projecting the mask pattern onto a second resist by using the focus offset and dose condition for manufacturing the semiconductor device; and
developing the second resist.

15. The method of claim 14, further comprising calculating a process window based on the functions.

16. The method of claim 15, further comprising displaying the process window in the coordinate plane.

17. The method of claim 15, further comprising defining the defocus and dose conditions at a center of the process window as an optimum focus offset and an optimum dose.

18. The method of claim 17, further comprising displaying the optimum focus offset and the optimum dose in the coordinate plane.
